(19) United States
(12) Patent Application Publication
(10) Pub. No.: US 2024/0001551 A1
(43) Pub. Date: Jan. 4, 2024

(54) AUTONOMOUS ROBOTIC ASSEMBLY OF ARBITRARY PART SHAPES

(71) Applicant: Worcester Polytechnic Institute, Worcester, MA (US)

(72) Inventors: Jing Xiao, Shrewsbury, MA (US); Shichen Cao, Framingham, MA (US); Huitan Mao, Malden, MA (US)

(21) Appl. No.: 18/204,509

(22) Filed: Jun. 1, 2023

Related U.S. Application Data
(60) Provisional application No. 63/348,477, filed on Jun. 2, 2022.

(51) Int. Cl. B25J 9/16; B25J 13/08

(52) U.S. Cl. CPC B25J 9/1664; B25J 13/085; B25J 9/1653; B25J 9/1661

(57) ABSTRACT

A 6-axis robot performs autonomous complex assembly based on a task-independent approach by directing a robotic member on a first approach trajectory for placement of a grasped object, and determining that placement along the first trajectory is blocked. The robotic member has an end-effector at a distal end configured for compressively grasping the object. Blockage is determined by force and torque sensing encountered by the end effector prior to attaining an intended pose or position. The robot identifies a second, alternate approach trajectory for placement of the grasped object based on a probability of success of the second approach trajectory, resulting from considering probabilities of candidate trajectories or positions. The robotic member continues iterative placement based on successive, alternate trajectories until placement is achieved. The robot attempts a successive placement around localized positions/trajectories in response to increased probabilities and decreased distance/error from the desired pose.

### RELATED APPLICATIONS

This patent application claims the benefit under 35 U.S.C. § 119(e) of U.S. Provisional Patent App. No. 63/348,477, filed Jun. 2, 2022, entitled “AUTONOMOUS ROBOTIC ASSEMBLY OF ARBITRARY PART SHAPES,” incorporated herein by reference in entirety.

### BACKGROUND

Robotic members are often sought for performing repetitive object placement tasks such as assembly and sorting of various objects or parts. An overarching challenge in autonomous assembly is the development of approaches that overcome various uncertainties to ensure the success and efficiency of robotic assembly motion. Uncertainties in assembly tasks are due to many factors, from object modeling inaccuracy to object pose sensing errors to uncertainty of robotic motion, which become non-trivial for tight-clearance assembly.

### SUMMARY

A 6-axis robot performs autonomous complex assembly based on a task-independent approach by directing a robotic member on a first approach trajectory for placement of a grasped object, and determining that placement along the first trajectory is blocked. The robotic member has an end-effector at a distal end configured for compressively grasping the object. Blockage is determined by force and torque sensing encountered by the end effector prior to attaining an intended pose or position. The robot identifies a second, alternate approach trajectory for placement of the grasped object based on a probability of success of the second approach trajectory, resulting from considering probabilities of candidate trajectories or positions. The robotic member continues iterative placement based on successive, alternate trajectories until placement is achieved. The robot attempts a successive placement around localized positions/trajectories in response to increased probabilities and decreased distance/error from the desired pose.

The disclosed approach teaches robotic assembly of arbitrary and complex-shaped parts in the presence of 6-dimensional uncertainty. When a nominal assembly motion of the robot holding a part is blocked by contact due to uncertainty, the disclosed approach finds the best estimates for the uncertainty and the contact configuration of the part based on sensed force/torque. The sensed force and torque information is employed to find a more accurate estimate of the goal configuration to guide a recovery motion of the part. The example configuration is based on a general, surface-based sphere tree representation of parts and a constrained optimization strategy to find the best estimate of the contact configuration under an uncertainty estimate. It relates computed force/torque and the sensed real force/torque through a learned force/torque calibration model. Example approaches depict the method applied and evaluated on two different complex-shaped multi-peg-in-hole tasks. The results show successful assembly with the presence of realistic 6-D uncertainties more than 10 times of the tight task clearances: orientation clearance (<0.01.5 rad) and position clearance (<1.5 mm).

The method for autonomous complex assembly based on a task-independent approach includes directing a robotic member on a first approach trajectory for placement of a grasped object, and determining that placement along the first approach trajectory is blocked, when the grasped object encounters interference with the intended placement destination. Placement logic identifies an alternate approach trajectory defined by a second approach trajectory for placement of the grasped object based on a probability of success of the second approach trajectory, and iterates placement attempts based on successive, alternate approach trajectories until placement is achieved.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram for robotic insertion of a grasped object;

FIG. 2 shows insertion of a complex shape suitable for use with configurations herein;

FIG. 3 shows a flowchart of object insertion for a grasped object such as in FIG. 2;

FIGS. 4A-4C shows point sampling of a complex object for insertion as in FIG. 3;

FIG. 5 shows iterations of placement positions as in FIG. 3; and

FIG. 6 shows decision branching for object placement based on the iterations as in FIG. 5.

### DETAILED DESCRIPTION

The description below presents an example of a robotic placement and assembly method, apparatus and system for a robotically controlled member such as an actuated claw or end effector achieving an orientation and pose for placing or inserting an object into a complementary position, object or receptacle based on a corresponding inverse shape or other ascertainable engagement.

Configurations herein employ a so-called 6-axis robot, which are known in the industry as capable of disposing a robotic actuator or member through 6 axes based on movement and rotation of interconnected robotic members. Typically this includes two articulated arms and a rotating base, although other suitable implementations may be employed.

The proposed approach enables automatic and flexible assembly of rigid parts, such as many kinds of insertion operations, by a general-purpose robot manipulator in a wide range of robotic applications, from smart manufacturing (with soft automation) to domestic services (for example, multi-pin plug-and-socket insertions). It addresses the need for efficient, adaptive, and soft automation for small-batch and customized part assembly in manufacturing, packaging with tight-clearance in material handling and logistics, domestic help for elderly or people with disability, nursing assistance, and other automated and/or repetitive tasks.

An overarching challenge in autonomous assembly is the development of approaches that overcome various uncertain-ties to ensure the success and efficiency of robotic assembly motion. Uncertainties in assembly tasks are due to many factors, from object modeling inaccuracy to object pose sensing errors to robot motion uncertainty, which become non-trivial for tight-clearance assembly. Conventional approaches pursue uncertainty reduction in robotic assembly tasks using passive compliance or active compliance based on force/torque sensing.

Force-based manipulation control strategies remain one of the main directions today, focusing on impedance control, hybrid force/position and passive-compliance control, and compliant control. The main disadvantage of the classic force-based control strategies is that they only apply to the assembly of simple-shape objects, such as single cylindrical or square peg-in-hole tasks with limited dimensions of uncertainty.

Visual perception is used to perceive object geometry and partial contact information in assembly tasks of complex-shaped object and to track and estimate assembly states. However, occlusions are major limiting factors for vision-based operations, which also require very high-resolution cameras to provide accurate sensing information.

Instead of requiring explicit knowledge of the objects, some literature exploits learning strategies to avoid using object models through reinforcement learning or learning by demonstration. Such conventional systems are only feasible on simple-shaped peg-in-hole tasks with specific initial conditions.

In order to deal with complex-shaped objects in contact-rich assembly environments, a Generative Adversarial Imitation Learning (GAIL) perspective is proposed by conventional approaches for gathering expert data through teleoperation. However, robustness may suffer because there is no feasible way to classify the contact force and the force applied by experts when collecting data. A sampling-based state estimation framework is presented by reusing samples in a motion generation step. However, this method assumes that the rotation error about the insertion axis is not observable, which is not realistic. An approach is presented to extract dense reward functions algorithmically for reinforcement learning in contact-rich manipulation tasks, but it is susceptible to uncertainty; if the peg is initially misaligned with the hole center, though close, the training will fail. A more recent method utilizes support vector machines (SVM) to classify the collected force data with adaptive impedance control for peg-in-hole assembly tasks. Although the object shape is not restricted in this method, it is very pose-sensitive since it requires a specific starting pose and moving trajectory.

Although there has been considerable work trying to handle some uncertainty in the autonomous assembly of complex-shaped objects, conventional approaches fall short of developing a robust approach to handle 6-dimensional uncertainty in the tight-clearance assembly of arbitrary-shaped parts. Furthermore, complex-shaped multi-peg-in-hole assembly is hardly broached by conventional approaches.

Configurations herein substantially overcome the shortcomings of conventional approaches by a general method for autonomous assembly of arbitrary complex-shaped parts in the presence of 6-D uncertainty. An iterative placement and reevaluation approach relies on force and torque sensing, and in an absence of visual imaging, which iterates for successive attempts, thus “close” attempts are correctible, rather than fatal.

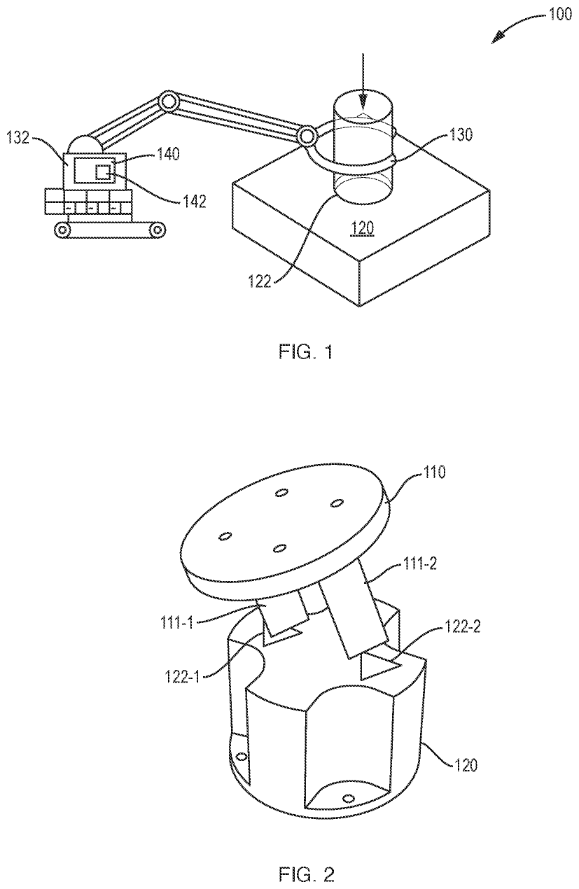

FIG. 1 is a context diagram for robotic insertion of a grasped object. FIG. 1 shows a robotic placement environment 100 where a grasped object 110 such as a peg is robotically inserted into a placement object 120, such as a receptacle 122 or cavity having a complementary shape to the grasped placement object 120. A robotic member 130, such as an end-effector, engages the grasped object 110, often driven by a 6 axis robot 132 for freedom of movement through the 3 dimensional space of the environment. Satisfaction of robotic placement of a peg-in-hole task of arbitrary shapes focuses on reducing orientation uncertainty along axes orthogonal to the direction of insertion and typically focuses on a single-step insertion. A control circuit 140 includes a processor and memory 142 having instructions for performing the placement task, as discussed further below.

The approach disclosed below addresses arbitrary 6-dimensional (6-D) position and orientation uncertainties in the relative configuration of arbitrary-shaped assembly parts, and enables active recovery motions to achieve assembly goals in multiple steps as needed. In other words, completion of the insertion via only a single step need not be expected because iterations of placement based on computed uncertainty are employed. Conventional approaches require exacting placement and collision with the object defines failure. The introduced general method for autonomous robotic assembly is characterized by the following features:
the capability of handling and overcoming 6-D position and orientation uncertainties in the relative configuration of the parts for assembly;
the capability of assembling parts of arbitrary, complex shapes, including those in complex multi-peg-in-hole tasks;
the capability of handling a wide range of uncertainty values; and
experimentally demonstrated effectiveness (i.e., high success rate) and efficiency in varied, complex multipeg-in-hole assembly cases.

FIG. 2 shows insertion of a complex shape suitable for use with configurations herein. Referring to FIGS. 1 and 2, the grasped object 110 is defined by a more complex shape including a plurality of projections 111-1 . . . 111-2 (111 generally) and corresponding receptacles 122-1 . . . 122-2 (122 generally). A noticeable tilt or pose of the grasped object 110 relative to the insertion object 120 can be observed.

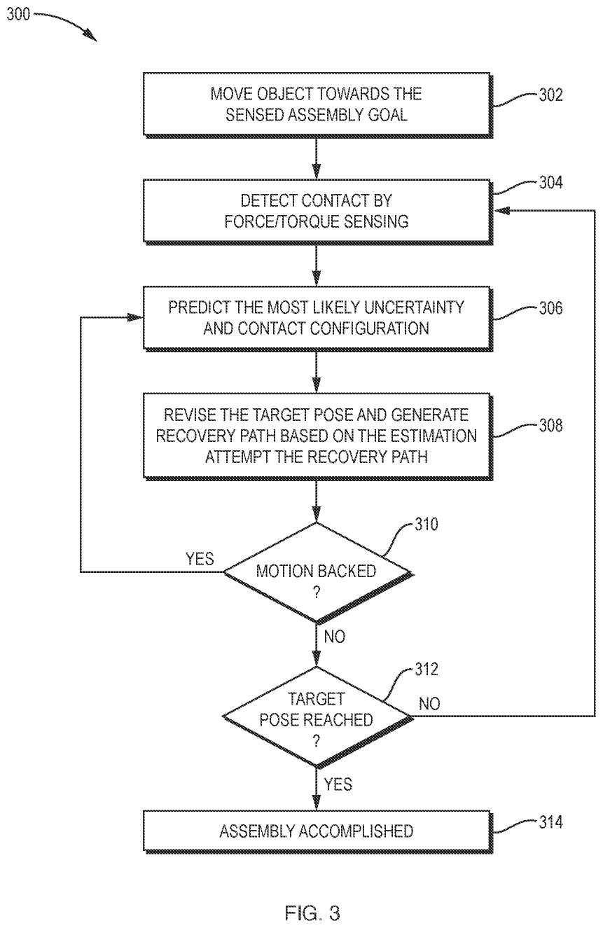

FIG. 3 shows a flowchart of object insertion for a grasped object 110 such as in FIG. 2. Referring to FIGS. 1-3, FIG. 3 depicts the disclosed method 300, as expressed in the operations and equations below. A surface-based sphere tree representation is invoked to model objects of arbitrary shapes in assembly tasks, as with the grasped objects 110 of FIGS. 1 and 2. A combined approach of modeling and perception finds the best estimate of the contact configuration when the assembly parts encounter interference in contact with the placement object 120 due to uncertainty during assembly, i.e. an off-target trajectory. An active recovery motion strategy adjusts the path of the assembly motion based on the best configuration estimate that reduces uncertainty. This process repeats each time when a new contact blocks the assembly motion due to uncertainty. Blockage is based on at least one of force and torque sensing encountered by the end effector 130. Hence, the active recovery strategy enables the parts to successfully converge to the goal configuration, meaning insertion or placement of the grasped object 110 onto or into the placement object 120.

Representing an object of arbitrary shape by a sphere tree is advantageous for efficient collision detection and contact reasoning among objects. Spheres are the easiest shapes for collision/contact detection, and a hierarchical organization of spheres into a tree structure enables quickly ruling out non-collision parts of the interacting objects and localizing collision parts. Hence, the disclosed approach employs a sphere-tree representation of parts for assembly. While there are many ways of forming spheres and trees given an object model (such as a fine mesh model), we build a surface-based sphere-tree representation by taking advantage of the fact that in most non-trivial assembly cases, the objects are columnar, where each layer shares the cross section of the same shape. Thus, the model of such an object can be generated by sweeping the boundary of a 2-D cross section.

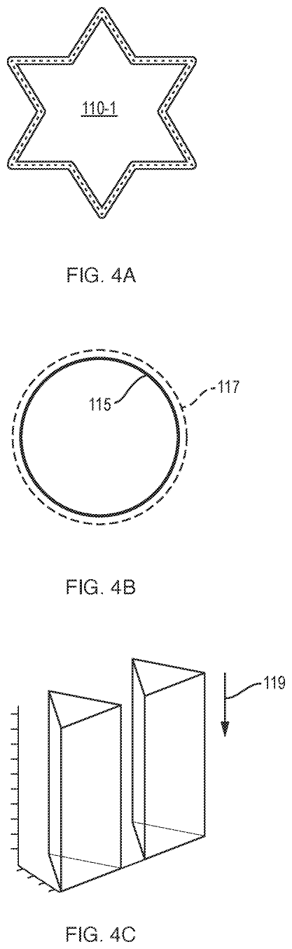

The disclosed method first evenly samples points along the boundary curve of the 2-D cross section and then sweeps the points in the direction of the column axis to form the 3-D surface cloud of the object. FIGS. 4A-4C shows point sampling of a complex object for insertion as in FIG. 2. Referring to FIGS. 1-4C, FIG. 4A shows the cross section boundary of a star-shaped prism. Next, our method expands every point into a sphere. We scale the object by a scale factor c so that the periphery of the spheres is tangent to the original object. FIG. 4B shows a solid cylinder's scaled and original boundary in 2-D space. For a hollow object (such as a hole structure), c>1; otherwise, c<1. We next expand the 2-D data to the 3-D space by adding another dimension along the sweeping direction, for example, as shown in FIGS. 4A-4C.

The grasped objects exhibit a columnar property by either overall chape or protrusions. Evaluating the position includes determining that the object has a columnar property, and forming a sphere tree defined by a surface-based representation including a set of similarly shaped cross sections oriented in an adjacency of 2-dimensional cross sections along a sweeping boundary. The disclosed approach first evenly samples points along the boundary curve of the 2-D cross section and then sweeps the points in the direction of the column axis to form the 3-D surface cloud of the object. FIG. 4A shows the cross section boundary of a star-shaped prism 110-1. Next, the method expands every point into a sphere. We scale the object by a scale factor c so that the periphery of the spheres is tangent to the original object. FIG. 4B shows a solid cylinder's scaled 117 and original 115 boundary in 2-D space. Scaling includes identifying a cross-section boundary of each cross section in the set of similarly shaped cross sections scaling each cross-section for alignment with a tangent to a periphery of the respective similarly shaped cross section. For a hollow object (such as a hole structure), c>1; otherwise, c<1. We next expand the 2-D data to the 3-D space by adding another dimension along the sweeping direction 119, for example, as shown in FIG. 4C.

The sphere-tree structure is formed using bottom-up sphere merging. By increasing the sphere's radius, the scale factor c grows, and the number of spheres decreases proportionally. In this manner, an upper-level sphere contains lower-level spheres as its children. Surface-based sphere tree representation can be applied to any columnar object without restriction on the shape. Our empirical studies suggest that such a surface-sphere tree representation is much more efficient than a volumetric octree representation of spheres.

Consider two objects obj₁ and obj₂ in a contact-rich robotic assembly task. We denote the surface-based sphere tree representation of the objects as Sobj₁ and Sobj₂ respectively. Let 0₁-xyz and 0₂-xyz be the local frames of obj₁ and obj₂ respectively. The configurations of obj₁ and obj₂ in the world frame can be denoted in terms of homogeneous transformation matrices wT₁ and wT₂ respectively.

Object obj₁ is rigidly attached to or grasped by the robot's end-effector, and obj₂ is static in the environment. Assume the pose wT₁ of obj₁ is accurately known (via the end-effector configuration), but the pose wT₂ of obj₂ is subject to 6-D position and orientation uncertainties. Thus, the relative pose of obj₁ with respect to obj₂ is also subject to 6-D uncertainties. i.e., the true relative pose T′, can be expressed as:

T′ᵣ=²T₁·ΔT,

where ²T₁ denotes the nominally sensed configuration and ΔT denotes the unknown uncertainty. Let ²Tg be the relative goal configuration of obj₁ with respect to obj₂ based on nominal data (i.e., without considering uncertainty). Thus, the true goal configuration T′_{g} can be expressed as:

T′_{g}=²T_{g}·ΔT,

where ²Tg is the nominal relative goal configuration computed from the nominally sensed relative configuration ²T₁.

In general, we can define the nominal assembly motion as depicted at step 302 without considering uncertainty as moving obj₁ from an initial relative configuration ²Tr with respect to obj₂ along the +z axis of its frame to the nominal relative goal configuration ²Tg.

The robot 132 starts by moving obj₁ to follow the nominal motion until a contact occurs due to uncertainty in the pose of obj₂, as shown at step 304. Step 306 then predicts the uncertainty ΔT and estimates the relative contact configuration geometrically and relating that to the sensed force/torque information. Based on the predicted ΔT, the control circuit 140 and processor create recovery motions to overcome the uncertainty to enable successful assembly. This involves identifying an alternate approach trajectory defined by a second approach trajectory for placement of the grasped object based on a probability of success of the second approach trajectory, and then iterating placement based on successive, alternate approach trajectories until placement is achieved. From the attempted placement/insertion and collision or contact with the placement object 120, the robot 132 senses an insertion force and torque based on a force/torque sensor on the robotic member, and searches a candidate set of uncertainty for identifying a best prediction from a correspondence to the sensed insertion force and torque. An iterative process computes the second (and successive) approach trajectories based on a mapping of the sensed insertion force and torque to the candidate set.

As obj₁ moves towards the goal configuration, it may collide and contact obj₂ at time t due to uncertainty, depicted at step 304. The contact force/torque is sensed by the force/torque sensor of the robot, but the relative contact configuration of obj₁ with respect to obj₂ is uncertain. The disclosed approach is to search for the best prediction of ΔT from a candidate set U of uncertainty, such that the force/torque computed based on the corresponding relative contact configuration matches the sensed force/torque. U can be achieved through discretization of an uncertainty range along each dimension of the 6-D configuration.

Given a prediction of ΔT, denote the corresponding relative configuration of obj₁ with respect to obj₂ at time t as a 6-D vector q(t) in (3) where [ϕ, θ, ψ] are the roll, pitch and yaw angles describing the relative orientation, and [x, y, z] describes the relative position:

q(t)=[ϕ(t),θ(t),ψ(t),x(t),y(t),z(t)]. (3)

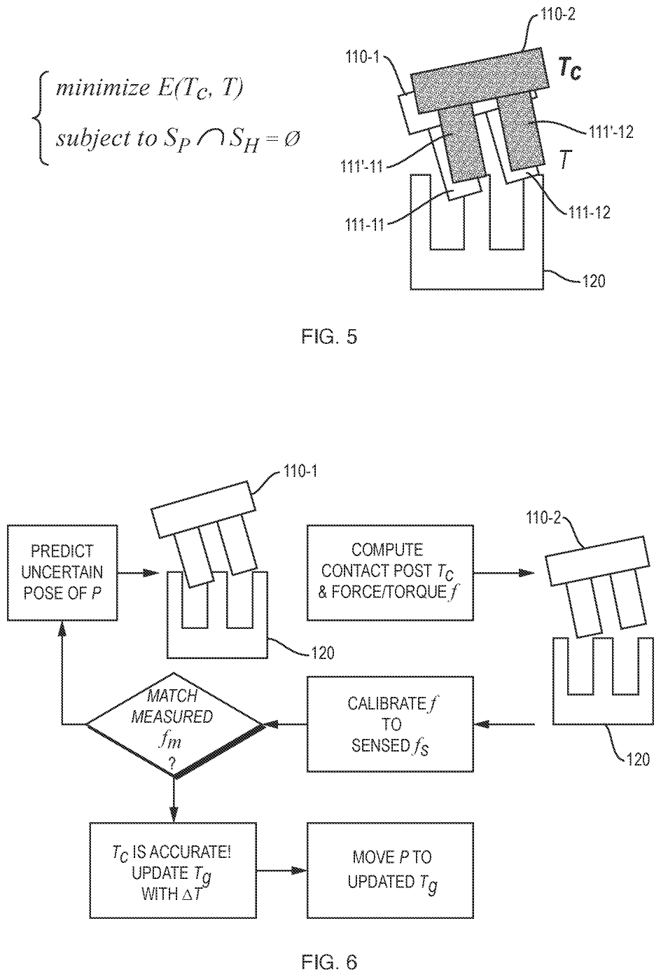

If a contact force/torque is sensed, q(t) should be a contact configuration. However, due to ΔT and modeling inaccuracy, the model Sabj₁, of obj₁ may either penetrate into the model Sobj₂ of obj₂ or not in contact with Sobj₂ at q(t) in simulation. In such a case, a configuration-based optimization is applied to estimate the most likely contact configuration q*(t) by minimizing the simulated elastic energy at time t, depicted at step 308 and discussed further in FIG. 5 below:

$$\{ \begin{matrix}minimize & E ( q , {q}^{*} ) , \\ subject to & \text{?} ⋂ {S}_{{obj}_{2} = ⌀} .\end{matrix}$$

$$\text{?} \text{indicates text missing or illegible when filed}$$

We further define Sobj1,i=(x_{1,i}, y_{1,i}, z_{1,i}, r_{1,i}). I=1, . . . ,n, and s_{obj2,j}=(x_{2,j}, y_{2,j}, z_{2,j}, r_{2,j}). j=1, . . . , m, as a spheres (leaf nodes) of the sphere-tree of the obj₁ and obj₂, respectively, where x, y, z describes the center of the sphere, and r represents the radius of the sphere. To fulfill the non-penetration constraints, we have:

(x_{1,i}−x_{2,j})²+(y_{1,i}−y_{2,j})²+(z_{1,i}−z_{2,j})²≥(r_{1,i}−r_{2,j})².

Let Cₖ^{t} be the minimum Euclidean distance between the k^{th} pair of spheres of the two objects respectively at time step t. We can further derive the nonlinear objective function and constraints in time step t as follows:

$$\{ \begin{matrix}minimize & \frac{1}{2} {( q - {q}^{*} )}^{T} G ( q - {q}^{*} ) \\ subject to & {C}_{k}^{t} ( {q}^{*} ) \geq 0 , k = 1 , 2 , … , N\end{matrix} ,$$

where N is the number of pairs of likely interacting spheres predicted by the contact constraint-prediction algorithm (CCP), which can accelerate the collision detection process. G is a 6×6 diagonal stiffness matrix representing the coefficients for the orientation and the translation.

To solve this nonlinear optimization problem efficiently, we leverage a linearization method to approximate the non-penetration constraints. Since the robot manipulator has a very high refresh rate, the change of the orientation and position of the obj₁ is relatively small at each time step. A first-order Taylor expansion is derived below to compute the configuration in the next time step t by omitting the high dimensional truncation error:

$${C}_{k}^{t} ( q ) \approx {C}_{k}^{t - 1} ( q ) \vert + {\sum }_{w = 1}^{6} \frac{\partial {C}_{k}^{t - 1} ( q )}{\partial {q ( t - 1 )}_{w}} [ {q ( t )}_{w} - {q ( t - 1 )}_{w} ] .$$

In order to further improve the performance, we derive:

$$\frac{\partial {C}_{k}^{t - 1} ( q )}{\partial q ( t - 1 )} = 2 [ \begin{matrix}Δ {p}^{T} {R}_{z , ϕ}^{′} \text{?} {R}_{x , ψ} d \\ Δ {p}^{T} {R}_{z , ϕ} \text{?} {R}_{x , ψ} d \\ Δ {p}^{T} {R}_{z , ϕ}^{′} {R}_{y , θ} {R}_{x , ψ} d \\ e\end{matrix} ] ,$$

$$\text{?} \text{indicates text missing or illegible when filed}$$

Where

e=R_{z,ϕ}R_{y,θ}R_{x,ψ}d+Δp,

And where R_{z,ϕ}, R_{y,ϕ} and R_{x,ϕ} are basic rotation matrices; Δp is the 3×1 distance vector between the kth pair of spheres S_{obj1} and S_{obj2} at time step t−1 respectively, and d is the 3×1 vector representing the center of the sphere of S_{obj2} in the kth pair. The Euclidean distance Cₖ^{t-1}(q) can be further computed by:

Cₖ^{t-1}(q)=e^{T}e−(r_{1,i}+r_{2,j})²,

where r₁,i and r₂,j indicate the radius of the spheres of the two objects in the kth pair respectively.

By linearizing the contact constraint function via Taylor expansion and reconstructing it in the matrix multiplication form, we converted the objective model optimization to a quadratic programming problem, which is then solved efficiently by leveraging a solver.

The difference between q and the resulting estimated contact configuration q* is next used to compute a contact force/torque estimate f_{c} based on Hooke's law.

If f_{c} matches the sensed real force/torque fₘ well after calibration, then the corresponding contact configuration q* is the best estimate q, and the corresponding predicted ΔT is the best uncertainty estimate. Otherwise, a new prediction of ΔT will be selected from set U, and the above process of estimating contact configuration and contact force/torque is repeated. Table I summarizes the procedure to estimate the contact configuration that best matches a measured force fₘ for a given of set U of uncertainty candidates.

TABLE I
Contact Configuration Estimation

| | |
|---|---|
| 1 | repeat: |
| 2 | pick a ΔT from U; U = U − {ΔT} |
| 3 | find the corresponding contact configuration T(q*); |
| 4 | compute the corresponding force/torq\|ue f_{c}; |
| 5 | input f_{c} to a calibration model to obtain fₛ (section |
| | III.E); |
| 6 | until fₛ matches fₘ |
| 7 | q′ = q*; |
| 8 | output (ΔT,T(q′)) |

The computed force/torque f_{c} could be different from the sensed real force/torque even in the best case, when they should match, because of approximation errors in modeling (i.e., in the sphere-tree representation of objects, the linearization of nonpenetration constraints, the force computation, and the force sensor uncertainty). Thus, our approach is to train a data-driven force calibration model to map the predicted force/torque f_{c} in the virtual environment to the sensed force/torque fₘ in the real world.

The force calibration model is a trained fully connected neural network that uses Rectified Linear Unit (ReLu) function as the activation, mean squared error (MSE) as loss function for regression, and stochastic gradient descent (SGD) with momentum for optimizing the objective function. Taking the predicted force/torque f_{c} as the input (with 6 values), the model outputs a contact force/torque fₛ (again with 6 values) to match the real-world sensed force/torque fₘ. Several models were investigated with different structures and different proportions of training data to obtain the suitable calibration model.

Once the best estimation of the uncertainty in the relative configuration of obj₁ with respect to obj₂ is found, the disclosed approach creates the corresponding estimate of the goal con-figuration and a recovery compliant motion path T to direct obj₁ to the estimated goal configuration from the current best estimate of the contact configuration. However, even with optimization, there can be more than one best estimate of the contact configuration, as shown in the example of FIG. 5 below, where the two contact poses correspond to two uncertainty estimates. The computed force/torque may or may not be the same for the two poses, but they share the same sensed real force/torque. This means that the true estimate can be either one of those estimates. Thus, our method first attempts to move obj1 along T (i.e., move by an extremely small step). The purpose of the attempt is to quickly decide whether or not the estimate is the true estimate without changing the contact configuration. If obj₁ is blocked, as depicted at step 310, the disclosed approach will call the Contact Configuration Estimation routine of Table I again to find the best estimate of the contact configuration starting from the next uncertainty estimate, and so on, until the true estimate of the contact configuration is found, based on the check at step 312, so that obj₁ can be moved to the assembly goal, as depicted at step 314. In rare cases, blocking is not detected during the attempt, and a finite motion can occur and be blocked again by contact. Now the contact configuration has been changed, and the whole procedure is run again to determine uncertainty and contact configuration estimates to conduct recovery motion. This process of actively determining the true contact configuration and the recovery motion is shown in the Active Recovery Motion Strategy routine in Table II.

TABLE II
Active Recovery Motion Strategy

| | |
|---|---|
| 1 | Record the measured contact force fₘ; |
| 2 | generate candidate uncertainty set |
| | U = {ΔTᵢ}, i = 1, ..., M by discretizing the |
| | uncertainty ranges; |
| 3 | call Algorithm 1 to obtain the best (ΔT,T(q′)); |
| 4 | revise target configuration to get the best estimate: |
| | T′_{g} =² T_{g} · ΔT: |
| 5 | generate a recovery path τ to connect T(q′) and T′_{g} |
| | in 6-D straight-line; |
| 6 | attempt τ; |
| 7 | if motion is blocked then |
| 8 | \| go to step 3 |
| 9 | else |
| 10 | \| compliantly move along τ\| |
| 11 | end if |
| 12 | if T′_{g} is reached then |
| 13 | \| “assembly finished” and exit |
| 14 | else |
| 15 | \| go to step 1 |
| 16 | end if |

An example is used to describe the implementation and apply our method to autonomous robotic multi-peg-in-hole assembly tasks of complex-shaped parts. Considering the 3D printing tolerance, the orientation clearance and position clearance between the peg and hole structure in each pair is smaller than 0.015 rad and 1.5 mm respectively.

Procedurally, the example employs a 7-DOF Franka Emika Panda arrn to securely hold a peg structure. The hole structure is connected to the end-effector of a 6-DOF ABB IRB 120 robot. The hole structure is fixed and static during the experiments. By adjusting the joint values of the ABB robot, the pose of the hole structure can be controlled. The hole's configuration is calculated by the Product of Exponentials Formula (POE). We generate 6-D uncertainty of the configuration of the hole structure by offsetting joints of the ABB robot. The 6-D uncertainty is not known by the Panda robot holding the peg structure.

The end-effector of the Panda arm is equipped with an ATI force/torque sensor [34], calibrated before the experiment. The sensor is used to collect force/torque data for training a neural network as the force calibration model. We devised and ran a program for automatic force data collection such that the manipulator makes different contact configurations between the assembly parts, and for each contact configuration, it computes f_{c} and collects force/torque sensing data fₛ. The total time for the changing a contact configuration and measuring the corresponding force/torque data is <3 seconds.

During the assembly motion, the peg structure is considered blocked if the sensed force/torque exceeds a threshold. The Panda robot will stop at the current contact configuration to measure the force/torque fₘ.

A model involved training a 6-32-32-6 neutral network (2 hidden layers with 32 neurons each) by collecting 4,096 input and output data pairs. The relative uncertainty range that our method uses is shown in Table III. Joint offsets were picked randomly for the ABB robot to generate the relative uncertainty within the given range.

TABLE III

| | Orientation Uncertainty (rad) | | | Position Uncertainty (mm) | | |
|---|---|---|---|---|---|---|
| Bound | Δϕ | Δθ | Δψ | Δx | Δy | Δz |
| + | 0.235 | 0.235 | 0.204 | 17.6 | 17.6 | — |
| − | −0.235 | −0.235 | −0.204 | −17.6 | −17.6 | −3.49 |

During the assembly motion, the peg structure is considered blocked if the sensed force/torque exceeds a threshold. The Panda robot will stop at the current contact configuration to measure the force/torque fₘ.

FIG. 5 shows iterations of placement positions as in FIG. 3. Referring to FIGS. 3-5 the grasped object 110-1 approaches the placement object 120 by actuating the robotic member 130 for moving the grasped object 110-1 along an approach trajectory until a contact against a placement object is determined as position T. The robot 140 determines an uncertainty in a pose of the placement object resulting from a misalignment between the grasped object 110-1 and the placement object 120, and computes recovery motions based on the uncertainty for defining the second approach trajectory and the uncertainty to achieve a changed pose Tc 110-2. Pose and alignment are affected by the positions of the protrusions 111-11 . . . 111-12 and alignment with the placement object at the changed position 111′-11 . . . 111′-12 (111′ generally), where the second approach trajectory attains an angle slightly more aligned with insertion of the projections 111′.

FIG. 6 shows decision branching for object placement based on the iterations as in FIG. 5. Referring to FIGS. 3-6, FIG. 6 shows the decision branches taken in the evaluation of the grasped object 110-1 in transition to position 110-2, as performed in step 308 of FIG. 3.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for autonomous complex assembly based on a task-independent approach, comprising:
directing a robotic member on a first approach trajectory for placement of a grasped object;
determining that placement along the first approach trajectory is blocked; and
identifying an alternate approach trajectory defined by a second approach trajectory for placement of the grasped object based on a probability of success of the second approach trajectory; and
iterating placement based on successive, alternate approach trajectories until placement is achieved.

2. The method of claim 1 wherein the robotic member is capable of actuated movement along 6 axes.

3. The method of claim 1 wherein the robotic member has an end-effector at a distal end configured for compressively grasping the object.

4. The method of claim 1 wherein determining blockage is based on at least one of force and torque sensing encountered by the end effector.

5. The method of claim 1 wherein the robotic member is attached to and driven by a 6-axis robotic actuator.

6. The method of claim 1 further comprising:
determining that the object has a columnar property, and
forming a sphere tree defined by a surface-based representation including a set of similarly shaped cross sections oriented in an adjacency of 2-dimensional cross sections along a sweeping boundary.

7. The method of claim 6 further comprising:
identifying a cross-section boundary of each cross section in the set of similarly shaped cross sections; and
scaling each cross-section for alignment with a tangent to a periphery of the respective similarly shaped cross section.

8. The method of claim 1 further comprising:
actuating the robotic member for moving the grasped object along an approach trajectory until a contact against a placement object is determined;
determining an uncertainty in a pose of the placement object resulting from a misalignment between the grasped object and the placement object; and
computing recovery motions based on the uncertainty for defining the second approach trajectory and the uncertainty.

9. The method of claim 8 further comprising:
sensing an insertion force and torque based on a force/torque sensor on the robotic member; and
searching a candidate set of uncertainty for identifying a best prediction from a correspondence to the sensed insertion force and torque; and
computing the second approach trajectory based on a mapping of the sensed insertion force and torque to the candidate set.

10. The method of claim 1 wherein the placement object has a receptacle having a periphery based on aa cross section of the grasped object, the receptacle adapted to receive the grasped object.
